(19) United States
(12) Patent Application Publication
(10) Pub. No.: US 2024/0117179 A1
(43) Pub. Date: Apr. 11, 2024

(54) PLASTIC WRAP

(71) Applicant: NAN YA PLASTICS CORPORATION, TAIPEI (TW)

(72) Inventors: TE-CHAO LIAO, TAIPEI (TW); CHING-YAO YUAN, TAIPEI (TW); Yu-Chi Hsieh, TAIPEI (TW)

(21) Appl. No.: 18/071,585

(22) Filed: Nov. 29, 2022

(30) Foreign Application Priority Data
Oct. 7, 2022 (TW) 111138158

(51) Int. Cl. C08L 67/02; B32B 7/02; B32B 27/08; B32B 27/18; B32B 27/36

(52) U.S. Cl. CPC C08L 67/02; B32B 7/02; B32B 27/08; B32B 27/18; B32B 27/36; B32B 2250/244; B32B 2270/00; B32B 2307/30; B32B 2307/412; B32B 2307/54; B32B 2307/7163; B32B 2307/732; B32B 2553/00; C08L 2205/025; C08L 2205/035

(57) ABSTRACT

A plastic wrap is provided. The plastic wrap is formed from a biodegradable material. The biodegradable material includes a biodegradable polymer and a chain extender. The biodegradable polymer includes polybutylene adipate terephthalate (PBAT). Based on a total weight of the plastic wrap being 100 phr, an amount of the PBAT is higher than 85 phr. The chain extender is selected from the group consisting of: an epoxy functional compound, a dianhydride compound, diisocyanate, phosphite, dioxazoline, and any combination thereof.

### CROSS-REFERENCE TO RELATED PATENT APPLICATION

This application claims the benefit of priority to Taiwan Patent Application No. 111138158, filed on Oct. 7, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a plastic wrap, and more particularly to a biodegradable plastic wrap for food.

### BACKGROUND OF THE DISCLOSURE

Plastic wraps are a commonly used food packaging product, and use of which allows dishes to be kept fresh and be prevented from getting mixed with other odors after being placed in a refrigerator. In a common household, a use frequency of the plastic wraps is very high. However, the plastic wraps are disposable packaging products that need to be discarded each time after use. In the long run, the discarded plastic wraps become a burden to the environment.

Moreover, the plastic wraps currently available on the market are mostly made of petrochemical plastics (e.g., polyvinyl chloride or polyethylene), which hardly decompose in the natural environment. As such, using the plastic wraps is not environmentally friendly, and this is an issue that has gradually gained attention of the public.

Some plastic wraps are manufactured with addition of oxidative degradation additives, and are claimed to be oxidatively degradable. However, it has been proven by the EU that although such plastic wraps can be disintegrated into plastic fragments, the plastic fragments still cannot be decomposed by the environment. Further, these plastic fragments contain heavy metal components, which can cause even more serious environmental damages. Accordingly, the oxidative degradation additives have been banned from use.

Therefore, how to improve the biodegradability of the plastic wrap through material-related improvements, so as to overcome the above-mentioned deficiencies, has become one of the important issues to be solved in this field.

### SUMMARY OF THE DISCLOSURE

In response to the above-referenced technical inadequacies, the present disclosure provides a plastic wrap.

In one aspect, the present disclosure provides a plastic wrap. The plastic wrap is formed from a biodegradable material. The biodegradable material includes a biodegradable polymer and a chain extender. The biodegradable polymer includes polybutylene adipate terephthalate (PBAT). Based on a total weight of the plastic wrap being 100 phr, an amount of the PBAT is higher than 85 phr. The chain extender is selected from the group consisting of: an epoxy functional compound, a dianhydride compound, diisocyanate, phosphite, dioxazoline, and any combination thereof.

In some embodiments, a melt index (MI) of the biodegradable material ranges from 2 g/10 min to 25 g/10 min.

In some embodiments, the biodegradable polymer further includes polylactic acid (PLA), polybutylene succinate (PBS) or any combination thereof.

In some embodiments, based on the total weight of the plastic wrap being 100 phr, the plastic wrap includes 85 phr to 95 phr of the PBAT, 1 phr to 5 phr of PLA, and 1 phr to 5 phr of PBS.

In some embodiments, the chain extender is selected from the group consisting of: a styrene-glycidyl methacrylate copolymer, a polyester polyol epoxy resin, pyromellitic dianhydride, maleic anhydride, tetrahydrophthalic anhydride, hexamethylene diisocyanate, toluene diisocyanate, diphenylmethane diisocyanate, m-xylylene diisocyanate, p-phenylene diisocyanate, dimethyl biphenyl diisocyanate, isophorone diisocyanate, lysine diisocyanate, polymethylene polyphenyl polyisocyanate, triphenyl phosphite, tris(2,4-di-tert-butylphenyl) phosphite, diisooctyl phenyl phosphite, bis(2,2′-methylene bis(4,6-di-tert-butylphenyl) phosphite), 2,2′-bis(2-oxazoline), 1,3-bis(2-oxazolidinyl-2-yl)benzene, and any combination thereof.

In some embodiments, based on a total weight of the biodegradable material being 100 phr, an amount of the chain extender ranges from 0.3 phr to 2 phr.

In some embodiments, a transmittance of the plastic wrap is greater than 95%, a haze of the plastic wrap is less than 2%, and a total thickness of the plastic wrap ranges from 0.005 mm to 0.02 mm.

In some embodiments, the plastic wrap includes an intermediate layer, a first surface layer, and a second surface layer. The intermediate layer has a first surface and a second surface opposite to each other, and a material forming the intermediate layer includes the PBAT, the chain extender, and at least one of PLA and PBS. The first surface layer is disposed on the first surface of the intermediate layer, and a material forming the first surface layer includes the PBAT and at least one of PLA and PBS. The second surface layer is disposed on the second surface of the intermediate layer, and a material forming the second surface layer includes the PBAT and at least one of PLA and PBS.

In some embodiments, the material forming the intermediate layer includes an anti-fog agent, a thickness of the intermediate layer is 3 times to 8 times a thickness of the first surface layer, and the thickness of the intermediate layer is 3 times to 8 times a thickness of the second surface layer.

In some embodiments, the material forming the first surface layer further includes a surface layer additive, the material forming the second surface layer further includes a surface layer additive, and the surface layer additive of each of the first surface layer and the second surface layer is selected from the group consisting of: oleamide, erucamide, calcium stearate, organosilane, and any combination thereof.

In some embodiments, based on a total weight of the first surface layer being 100 phr, an amount of the surface layer additive ranges from 0.1 phr to 1 phr. Based on a total weight of the second surface layer being 100 phr, an amount of the surface layer additive ranges from 0.1 phr to 1 phr.

Therefore, in the plastic wrap provided by the present disclosure, by virtue of “the biodegradable material including a biodegradable polymer and a chain extender” and “the biodegradable polymer including PBAT,” a biodegradable plastic wrap for food can be manufactured. Further, the plastic wrap has an appropriate tensile strength, an appropriate elongation rate, and an appropriate Young's modulus.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic side view of a plastic wrap according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

To overcome the problem of poor decomposability of a conventional plastic wrap (which can cause a burden to the environment), the present disclosure provides a biodegradable plastic wrap for food. The plastic wrap of the present disclosure is formed from a biodegradable material. Specifically, the biodegradable material includes a biodegradable polymer and a chain extender. Therefore, the plastic wrap of the present disclosure can be biodegraded (with a decomposition rate of above 90%) within a certain period of time. In addition, since the material of the plastic wrap does not contain metal additives, there is no secondary pollution to the environment after decomposition.

The biodegradable polymer includes polybutylene adipate terephthalate (PBAT), and uses the PBAT as its main component, thereby achieving a flexibility, a tensile strength, and an elongation rate required by the plastic wrap and having the advantage of high biodecomposability. Specifically, based on a total weight of the plastic wrap being 100 phr, an amount of the PBAT in the plastic wrap is higher than 85 phr.

In addition to the PBAT, it is optional for the biodegradable polymer to further include: polylactic acid (PLA), polyhydroxyalkanoate (PHA), polybutylene succinate (PBS), polycaprolactone (PCL), polyvinyl alcohol (PVA) or any combination thereof.

In one exemplary embodiment, the biodegradable polymer uses the PBAT as its main component, and further includes the PLA, the PBS or a mixture thereof. Preferably, based on the total weight of the plastic wrap being 100 phr, the plastic wrap includes 85 phr to 95 phr of the PBAT, 1 phr to 5 phr of the PLA, and 1 phr to 5 phr of the PBS. The overall physical properties of the plastic wrap can be improved by blending with a small amount of the PLA and the PBS. By introducing a small amount of the PLA, the plastic wrap can have improved rigidity and increased stiffness, and a dispensing property of a film roll of the plastic wrap can be enhanced. By introducing a small amount of the PBS, the plastic wrap can have improved viscoelasticity and increased extensibility.

A molecular weight and a crosslinking degree of the biodegradable polymer can be increased by adding the chain extender. In this way, the physical properties (e.g., hydrolysis resistance properties, compatibility, processing properties, and flexibility) of the biodegradable polymer can be enhanced, thereby improving the tensile strength and the elongation rate of a plastic wrap 1.

In addition, the chain extender of the present disclosure has a bridging effect, which has a tendency of allowing the biodegradable polymer to form a biodegradable material having a plurality of branches. From a melt index (MI) of the biodegradable material, the above-mentioned effect can be observed. Specifically, the MI of the biodegradable material ranges from 2 g/10 min to 25 g/10 min. Preferably, the MI of the biodegradable material ranges from 5 g/10 min to 20 g/10 min.

The chain extender of the present disclosure has at least two or more reactive functional groups (e.g., an epoxy group, an acidic group, a cyanate group or an ester group). For example, the chain extender is selected from the group consisting of: an epoxy functional compound, a dianhydride compound, diisocyanate, phosphite, dioxazoline, and any combination thereof. The epoxy functional compound mentioned above refers to a compound that contains an epoxy functional group. Compared with chain extenders of diisocyanate and dioxazoline, a chain extender of an epoxy functional compound has a wider source and lower costs, and is safe and nontoxic.

Specifically, the epoxy functional compound that can be used as the chain extender may be a styrene-glycidyl methacrylate copolymer or a polyester polyol epoxy resin. The dianhydride compound that can be used as the chain extender may be pyromellitic dianhydride, maleic anhydride or tetrahydrophthalic anhydride. The diisocyanate that can be used as the chain extender may be hexamethylene diisocyanate, toluene diisocyanate, diphenylmethane diisocyanate, m-xylylene diisocyanate, p-phenylene diisocyanate, dimethyl biphenyl diisocyanate, isophorone diisocyanate, lysine diisocyanate or polymethylene polyphenyl polyisocyanate. The phosphite that can be used as the chain extender may be triphenyl phosphite, tris(2,4-di-tert-butylphenyl) phosphite, diisooctyl phenyl phosphite, or bis(2,2′-methylene bis(4,6-di-tert-butylphenyl) phosphite). The dioxazoline that can be used as the chain extender may be 2,2′-bis(2-oxazoline) or 1,3-bis(2-oxazolidinyl-2-yl)benzene.

For the biodegradable material to have an appropriate crosslinking degree, based on a total weight of the biodegradable material being 100 phr, an added amount of the chain extender ranges from 0.1 phr to 3 phr. When the added amount of the chain extender is less than 0.1 phr, the physical properties of the biodegradable polymer cannot be effectively improved. When the added amount of the chain extender is greater than 3 phr, the molecular weight and the crosslinking degree of the biodegradable polymer are excessively high, which is not conducive to a film manufacturing process.

In some embodiments, based on the total weight of the biodegradable material being 100 phr, the added amount of the chain extender may be 0.2 phr, 0.4 phr, 0.6 phr, 0.8 phr, 1 phr, 1.2 phr, 1.4 phr, 1.6 phr, 1.8 phr, 2 phr, 2.2 phr, 2.4 phr, 2.6 phr, 2.8 phr or 3 phr. Preferably, the added amount of the chain extender ranges from 0.3 phr to 2 phr.

According to the selection of the above-mentioned materials, the plastic wrap of the present disclosure has biodegradability, and the physical properties thereof are comparable to those of commercially available plastic wraps. Its specific biodegradability and physical properties will be described below. In addition, appearance-wise, the plastic wrap 1 of the present disclosure has light transmittance and a low haze, such that observation of the type of food preserved thereby is easy. Specifically, a transmittance of the plastic wrap 1 can be above 95%, the haze of the plastic wrap 1 is less than 2%, and a thickness of the plastic wrap 1 ranges from 0.005 mm to 0.02 mm.

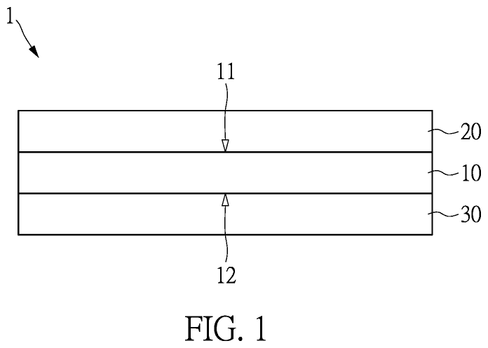

Referring to FIG. 1, FIG. 1 is a schematic side view of a plastic wrap according to an embodiment of the present disclosure. The plastic wrap 1 of the present disclosure may be a three-layer structure or a structure with more than three layers, and may be manufactured through a film blowing technology or a tape casting process. However, a method for manufacturing the plastic wrap 1 of the present disclosure is not limited thereto.

Specifically, the plastic wrap 1 includes an intermediate layer 10, a first surface layer 20, and a second surface layer 30. The intermediate layer 10 has a first surface 11 and a second surface 12 opposite to each other. The first surface layer 20 is disposed on the first surface 11 of the intermediate layer 10, and the second surface layer 30 is disposed on the second surface 12 of the intermediate layer 10. That is, the intermediate layer 10 is disposed between the first surface layer 20 and the second surface layer 30.

The intermediate layer 10, the first surface layer 20, and the second surface layer 30 of the present disclosure are each formed from a biodegradable material, such that the plastic wrap 1 is biodegradable and does not cause a burden to the environment. The biodegradable material mentioned here is similar to the above-mentioned biodegradable material forming the plastic wrap. That is, this biodegradable material includes a biodegradable polymer and a chain extender. The biodegradable polymer uses PBAT as its main component, and other biodegradable polymers (e.g., PLA, PHA, PBS, PCL, PVA or any combination thereof) may also be optionally added. The chain extender is similar to the type mentioned above, which will not be reiterated herein.

It should be noted that some processing aids may be added to the biodegradable material forming the intermediate layer 10, the first surface layer 20, and the second surface layer 30, so that each layer has other properties. The added processing aids are described below. It is worth mentioning that the above-mentioned processing aids do not include a processing aid that contains metal. Therefore, the plastic wrap 1 of the present disclosure does not include a metal component, and the plastic wrap 1 does not contaminate the environment after decomposition.

An anti-fog agent may be optionally added to the biodegradable material forming the intermediate layer 10. The addition of the anti-fog agent can mitigate the problem of fog formation due to different temperatures at both sides of the plastic wrap 1. Based on a total weight of the intermediate layer 10 being 100 phr, an added amount of the anti-fog agent ranges from 0.1 phr to 4 phr. Preferably, the added amount of the anti-fog agent ranges from 0.1 phr to 1 phr. The anti-fog agent may be xylitol ester, sorbitan monopalmitate, lauric acid or stearic acid monoglyceride. However, the present disclosure is not limited thereto.

A tackifier may be optionally added to the biodegradable material forming the intermediate layer 10. The addition of the tackifier allows the biodegradable polymer to have an improved processability and an improved wrapping property. Based on the total weight of the intermediate layer 10 being 100 phr, an added amount of the tackifier ranges from 0.1 phr to 4 phr. Preferably, the added amount of the tackifier ranges from 0.1 phr to 1 phr. Specifically, the type of the tackifier may be phthalate, fatty acid ester, carboxylate, phosphate, epoxy ester, or any combination thereof. However, the present disclosure is not limited thereto.

To prevent the anti-fog agent and the tackifier in the intermediate layer 10 from leaking to the surface of the plastic wrap, the first surface layer 20 and the second surface layer 30 are used to wrap the intermediate layer 10 in the present disclosure. In this way, the effect of blocking migration of the anti-fog agent and the tackifier can be achieved. Specifically, a thickness of the intermediate layer 10 in the present disclosure is 3 times to 8 times a thickness of the first surface layer 20, and the thickness of the intermediate layer 10 is 3 times to 8 times a thickness of the second surface layer 30.

An antibacterial agent may be optionally added to the biodegradable material forming the surface layers (i.e., the first surface layer 20 and the second surface layer 30). Due to the addition of the antibacterial agent, the plastic wrap 1 has an antibacterial effect. Based on a total weight of the surface layer (i.e., the first surface layer 20 or the second surface layer 30) being 100 phr, an added amount of the antibacterial agent ranges from 0.1 phr to 0.5 phr. The antibacterial agent may be nano-silver ions or a compound that contains the nano-silver ions. However, the present disclosure is not limited thereto.

A surface layer additive may be optionally added to the biodegradable material forming the surface layers (i.e., the first surface layer 20 and the second surface layer 30). Due to the addition of the surface layer additive, the plastic wrap 1 has a smooth surface and is convenient for use. Based on the total weight of the surface layer (i.e., the first surface layer 20 or the second surface layer 30) being 100 phr, an added amount of the surface layer additive ranges from 0.1 phr to 1 phr. Preferably, the added amount of the surface layer additive ranges from 0.3 phr to 0.5 phr. The surface layer additive may be oleamide, erucamide, calcium stearate, organosilane or any combination thereof. However, the present disclosure is not limited thereto.

The tackifier may be optionally added to the biodegradable material forming the surface layers (i.e., the first surface layer 20 and the second surface layer 30). The addition of the tackifier allows the biodegradable polymer to have an improved processability. Based on the total weight of the surface layer being 100 phr, an added amount of the tackifier ranges from 0.1 phr to 4 phr. Preferably, the added amount of the tackifier ranges from 0.1 phr to 1 phr. Specifically, the type of the tackifier may be phthalate, fatty acid ester, carboxylate, phosphate, epoxy ester, or any combination thereof. However, the present disclosure is not limited thereto.

Through the film blowing technology or the tape casting process, the plastic wrap of the present disclosure can be manufactured from the biodegradable material mentioned above. Specifically, biodegradable materials required for forming the intermediate layer 10, the first surface layer 20, and the second surface layer 30 are first prepared, and a plurality of biodegradable grains are manufactured by an extruder. By using the biodegradable grains, the biodegradable materials that satisfy the above-mentioned component content requirements can be obtained. Accordingly, the intermediate layer 10, the first surface layer 20, and the second surface layer 30 are respectively manufactured. Then, the biodegradable grains are fed into the extruder, so that the plastic wrap of the present disclosure (having a three-layer structure) can be manufactured through the film blowing technology or the tape casting process. In addition, the intermediate layer 10, the first surface layer 20, and the second surface layer 30 are integrally formed.

In one exemplary embodiment, the plastic wrap in the present disclosure is manufactured through the film blowing technology. In a film blowing process, a temperature of the extruder is set to be 120° C. to 160° C., and a temperature set for a die of the extruder ranges from 120° C. to 140° C. The plastic wrap is formed at a stretching speed of 30 meters/minute to 40 meters/minute. A temperature of introduced cooling air is set to be 10° C. to 20° C. A blow-up ratio of the plastic wrap ranges from 1.5 to 3.5. Preferably, the blow-up ratio of the plastic wrap ranges from 2 to 2.5.

To verify that the plastic wrap of the present disclosure can have excellent biodecomposability, different biodegradable materials are manufactured in the present disclosure, and are used to form the intermediate layer 10, the first surface layer 20, and the second surface layer 30. The biodegradable materials forming the intermediate layer 10, the first surface layer 20, and the second surface layer 30 are listed in Table 1. A thickness, a haze, a wrapping property, an after-tackiness, a tensile strength, an elongation rate, and a Young's modulus of the manufactured plastic wrap are further measured. Measurement results are listed in Table 1.

In Table 1, regarding the judgment standard of the wrapping property, the plastic wrap is used to cover objects under test that are made of glass and ceramic. If the plastic wrap can be completely attached to the object under test, it is indicated by “0”. If the plastic wrap cannot be attached to the object under test, it is indicated by “x”. Regarding the judgment standard of the after-tackiness, the plastic wrap is used to cover the objects under test that are made of glass and ceramic. If the plastic wrap can be completely attached to the object under test and allows repeated adherence, it is indicated by “0”. If the plastic wrap can be attached to the object under test and partially allows repeated adherence, it is indicated by “A”. If the plastic wrap can be attached to the object under test but does not allow repeated adherence, it is indicated by “X”. The tensile strength and the Young's modulus are measured by using a tensile strength testing machine.

In Table 1, the biodegradable polymer used in Examples 1 to 6 is the PBAT, and is blended with one of the PLA and the PBS. The tackifier used in Examples 1 to 6 is a carboxylate (acetyltributylcitrate). The biodegradable material in Comparative Example 1 contains only a biodegradable polymer (PBAT) and is without addition of a chain extender. Comparative Example 2 is a polyethylene plastic wrap currently available on the market, which is not manufactured from a biodegradable material.

TABLE 1

| | | | | | | | | | Comparative | |
|---|---|---|---|---|---|---|---|---|---|---|
| Biodegradable material | | | Examples | | | | | | Examples | |
| (Unit: phr) | | | 1 | 2 | 3 | 4 | 5 | 6 | 1 | 2 |
| Intermediate | PBAT | | 90 | 90 | 90 | 90 | 90 | 90 | 100 | — |
| layer | PLA | | 5 | 5 | 5 | 5 | 5 | — | — | — |
| | PBS | | 5 | 5 | 5 | 5 | — | 5 | — | — |
| | Chain | Polyester | 0.5 | — | — | — | — | — | — | — |
| | extender | polyol | | | | | | | | |
| | | epoxy resin | | | | | | | | |
| | | Pyromellitic | — | 0.5 | — | — | 0.5 | 0.5 | — | — |
| | | dianhydride | | | | | | | | |
| | | P- | — | — | 0.5 | — | — | — | — | — |
| | | phenylene | | | | | | | | |
| | | diisocyanate | | | | | | | | |
| | | Triphenyl | — | — | — | 0.5 | — | — | — | — |
| | | phosphite | | | | | | | | |

| | | | | | | | | | |
|---|---|---|---|---|---|---|---|---|---|
| | Tackifier | 0.5 | 0.5 | 0.5 | 0.5 | 0.5 | 0.5 | 0.5 | — |
| | Anti-fog agent | 0.5 | 0.5 | 0.5 | 0.5 | 0.5 | 0.5 | 0.5 | — |
| First | PBAT | 90 | 90 | 90 | 90 | 90 | 90 | 100 | — |
| surface | PLA | 5 | 5 | 5 | 5 | 5 | — | — | — |
| layer | PBS | 5 | 5 | 5 | 5 | — | 5 | — | — |
| | Antibacterial agent | 0.1 | 0.1 | 0.1 | 0.1 | 0.1 | 0.1 | 0.1 | — |
| | Tackifier | 0.2 | 0.2 | 0.2 | 0.2 | 0.2 | 0.2 | 0.2 | — |
| | Surface layer | 0.2 | 0.2 | 0.2 | 0.2 | 0.2 | 0.2 | 0.2 | — |
| | additive | | | | | | | | |
| Second | PBAT | 90 | 90 | 90 | 90 | 90 | 90 | 100 | — |
| surface | PLA | 5 | 5 | 5 | 5 | 5 | — | — | — |
| layer | PBS | 5 | 5 | 5 | 5 | — | 5 | — | — |
| | Antibacterial agent | 0.1 | 0.1 | 0.1 | 0.1 | 0.1 | 0.1 | 0.1 | — |
| | Tackifier | 0.2 | 0.2 | 0.2 | 0.2 | 0.2 | 0.2 | 0.2 | — |
| | Surface layer | 0.2 | 0.2 | 0.2 | 0.2 | 0.2 | 0.2 | 0.2 | — |
| | additive | | | | | | | | |

Properties of the plastic wrap

| | | | | | | | | |
|---|---|---|---|---|---|---|---|---|
| Thickness (mm) | 10 | 10 | 10 | 10 | 10 | 10 | 10 | 10 |
| Haze (%) | 1.25 | 1.27 | 1.25 | 1.30 | 1.6 | 1.20 | 1.10 | 1.5 |
| Wrapping property | ∘ | ∘ | Δ | Δ | ∘ | Δ | x | ∘ |
| After-tackiness | Δ | ∘ | Δ | ∘ | Δ | ∘ | ∘ | ∘ |
| Tensile strength (kg/cm²) | 212.9 | 323.5 | 217.3 | 191.7 | 385.5 | 230.2 | 254.5 | 200.2 |
| Elongation rate (%) | 770.7 | 931.6 | 683.8 | 694.6 | 540.2 | 810.2 | 861.9 | 658.6 |
| Young's modulus (kg/mm²) | 4.72 | 4.84 | 4.65 | 4.32 | 3.57 | 4.20 | 5.17 | 5.2 |

From the content in Table 1, it can be observed that the plastic wrap of the present disclosure has a low haze property (less than 2%, or even less than or equal to 1.6%), an excellent wrapping property and an excellent after-tackiness. In addition, the plastic wrap has a tensile strength ranging from 180 kg/cm² to 400 kg/cm², an elongation rate ranging from 530% to 950%, and a Young's modulus ranging from 3.5 kg/mm² to 5.0 kg/mm². Therefore, the plastic wrap of the present disclosure can replace the plastic wraps currently available on the market.

Compared with Comparative Example 1 (without addition of the chain extender, the PLA, and the PBS), the plastic wrap of the present disclosure has excellent tactile feel and after-tackiness. Compared with the plastic wrap in Comparative Example 2 (i.e., the polyethylene plastic wrap currently available on the market), the plastic wrap of the present disclosure has an appropriate tensile strength, an appropriate Young's modulus, and an obviously improved elongation rate, and thus can replace non-biodegradable plastic wraps currently available on the market.

In addition, to verify that the plastic wrap 1 of the present disclosure has biodegradability, according to the D6400 standard stipulated by the American Society of Testing Materials (ASTM), a biological decomposition test is performed on the plastic wrap 1 in Example 2 of the present disclosure. Test results are listed in Table 2.

TABLE 2

| | |
|---|---|
| Decomposition time | Decomposition rate |

| | | |
|---|---|---|
| 30 | days | 12.1% |
| 60 | days | 35.2% |
| 90 | days | 50.6% |
| 120 | days | 71.5% |
| 150 | days | 85.7% |
| 180 | days | 95.9% |

As can be observed from the results in Table 2, the plastic wrap 1 of the present disclosure indeed has biodegradability. In addition, according to the ASTM D6400 standard, the plastic wrap is tested to have biodecomposability of more than 90% after 180 days. Even better, according to the ASTM D6400 standard, the plastic wrap is tested to have biodecomposability of more than 95% after 180 days.

### Beneficial Effects of the Embodiments

In conclusion, in the plastic wrap provided by the present disclosure, by virtue of “the biodegradable material including a biodegradable polymer and a chain extender” and “the biodegradable polymer including PBAT,” a biodegradable plastic wrap for food can be manufactured, and can have an appropriate tensile strength, an appropriate elongation rate, and an appropriate Young's modulus.

Further, in the present disclosure, by virtue of “based on the total weight of the plastic wrap 1 being 100 phr, the plastic wrap 1 including 85 phr to 95 phr of the PBAT,” the plastic wrap 1 can have biodegradability.

Further, in the present disclosure, by virtue of “a melt index of the biodegradable material ranging from 2 g/10 min to 25 g/10 min,” the physical properties of the plastic wrap 1 can be improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A plastic wrap, comprising a biodegradable material, wherein the biodegradable material includes a biodegradable polymer and a chain extender, and the biodegradable polymer includes polybutylene adipate terephthalate (PBAT); wherein, based on a total weight of the plastic wrap being 100 phr, an amount of the PBAT is higher than 85 phr; wherein the chain extender is selected from the group consisting of: an epoxy functional compound, a dianhydride compound, diisocyanate, phosphite, dioxazoline, and any combination thereof.

2. The plastic wrap according to claim 1, wherein a melt index (MI) of the biodegradable material ranges from 2 g/10 min to 25 g/10 min.

3. The plastic wrap according to claim 1, wherein the biodegradable polymer further includes polylactic acid (PLA), polybutylene succinate (PBS) or any combination thereof.

4. The plastic wrap according to claim 1, wherein, based on the total weight of the plastic wrap being 100 phr, the plastic wrap includes 85 phr to 95 phr of the PBAT, 1 phr to 5 phr of polylactic acid (PLA), and 1 phr to 5 phr of polybutylene succinate (PBS).

5. The plastic wrap according to claim 1, wherein the chain extender is selected from the group consisting of: a styrene-glycidyl methacrylate copolymer, a polyester polyol epoxy resin, pyromellitic dianhydride, maleic anhydride, tetrahydrophthalic anhydride, hexamethylene diisocyanate, toluene diisocyanate, diphenylmethane diisocyanate, m-xylylene diisocyanate, p-phenylene diisocyanate, dimethyl biphenyl diisocyanate, isophorone diisocyanate, lysine diisocyanate, polymethylene polyphenyl polyisocyanate, triphenyl phosphite, tris(2,4-di-tert-butylphenyl) phosphite, diisooctyl phenyl phosphite, bis(2,2′-methylene bis(4,6-di-tert-butylphenyl) phosphite), 2,2′-bis(2-oxazoline), 1,3-bis(2-oxazolidinyl-2-yl)benzene, and any combination thereof.

6. The plastic wrap according to claim 1, wherein, based on a total weight of the biodegradable material being 100 phr, an amount of the chain extender ranges from 0.3 phr to 2 phr.

7. The plastic wrap according to claim 1, wherein a transmittance of the plastic wrap is greater than 95%, a haze of the plastic wrap is less than 2%, and a total thickness of the plastic wrap ranges from 0.005 mm to 0.02 mm.

8. The plastic wrap according to claim 1, further comprising:
an intermediate layer having a first surface and a second surface opposite to each other, wherein a material forming the intermediate layer includes the PBAT, the chain extender, and at least one of polylactic acid (PLA) and polybutylene succinate (PBS);
a first surface layer disposed on the first surface of the intermediate layer, wherein a material forming the first surface layer includes the PBAT and at least one of PLA and PBS; and
a second surface layer disposed on the second surface of the intermediate layer, wherein a material forming the second surface layer includes the PBAT and at least one of PLA and PBS.

9. The plastic wrap according to claim 8, wherein the material forming the intermediate layer includes an anti-fog agent, a thickness of the intermediate layer is 3 times to 8 times a thickness of the first surface layer, and the thickness of the intermediate layer is 3 times to 8 times a thickness of the second surface layer.

10. The plastic wrap according to claim 8, wherein the material forming the first surface layer further includes a surface layer additive, the material forming the second surface layer further includes a surface layer additive, and the surface layer additive of each of the first surface layer and the second surface layer is selected from the group consisting of: oleamide, erucamide, calcium stearate, organosilane, and any combination thereof.

11. The plastic wrap according to claim 10, wherein, based on a total weight of the first surface layer being 100 phr, an amount of the surface layer additive ranges from 0.1 phr to 1 phr; wherein, based on a total weight of the second surface layer being 100 phr, an amount of the surface layer additive ranges from 0.1 phr to 1 phr.
